(19) United States
(12) Patent Application Publication
(10) Pub. No.: US 2017/0045085 A1
(43) Pub. Date: Feb. 16, 2017

(54) BEARING STRUCTURE AND TURBOCHARGER

(71) Applicant: IHI Corporation, Koto-ku (JP)

(72) Inventors: Tomomi SUGIURA, Tokyo (JP); Yutaka UNEURA, Tokyo (JP)

(73) Assignee: IHI Corporation, Koto-ku (JP)

(21) Appl. No.: 15/338,899

(22) Filed: Oct. 31, 2016

Related U.S. Application Data
(63) Continuation of application No. PCT/JP2015/066012, filed on Jun. 3, 2015.

(30) Foreign Application Priority Data
Jun. 12, 2014 (JP) 2014-121303

(51) Int. Cl. F16C 33/10; F16C 17/02; F16C 17/18; F02B 39/14

(52) U.S. Cl. CPC F16C 33/1065; F02B 39/14; F16C 17/02; F16C 17/18; F16C 2360/24

(57) ABSTRACT

A bearing structure includes a shaft including an wheel provided at least at one end and a semi-floating metal bearing rotatably supporting the shaft. The semi-floating metal bearing has a main body including a cylindrical shape, a bearing surface formed on an inner circumferential surface of the main body and supporting the shaft, and a plurality of bearing grooves provided at intervals in a circumferential direction in the bearing surface and extending from one end to the other end of the shaft in a rotation axis direction. At least one of a shape and arrangement of the plurality of bearing grooves is asymmetrical to a center of a rotation axis in a section perpendicular to the rotation axis of the shaft.

### CROSS REFERENCE TO RELATED APPLICATIONS

This application is a continuation application of International Application No. PCT/JP2015/066012, filed on Jun. 3, 2015, which claims priority to Japanese Patent Application No. 2014-121303, filed on Jun. 12, 2014, the entire contents of which are incorporated by reference herein.

### BACKGROUND

1. Technical Field

The present disclosure relates to a bearing structure in which a shaft is supported by a bearing portion and to a turbocharger.

2. Description of the Related Art

Conventionally, there is known a turbocharger in which a shaft including a turbine wheel provided on one end and a compressor wheel provided on the other end is rotatably supported by a bearing housing. Such a turbocharger is connected to an engine, and the turbine wheel is rotated by an exhaust gas exhausted from the engine, while the compressor wheel is rotated through the shaft by rotation of this turbine wheel. As described above, the turbocharger compresses air with rotation of the compressor wheel and sends it out to the engine.

In the bearing housing, a bearing hole is formed, and a bearing is disposed in the bearing hole. The bearing has an insertion hole through which the shaft is inserted, and a bearing surface for receiving a radial load is formed on an inner circumferential surface thereof. As one of such bearing provided in the turbocharger, a semi-floating metal bearing and a full-floating metal bearing are known. In the semi-floating metal bearing, movement of the shaft in a rotating direction is regulated, while the full-floating metal bearing rotates with rotation of the shaft (so-called drag rotation). The semi-floating metal bearing is provided in the turbocharger described in Japanese Patent Application Laid-Open Publication No. 2012-193709 (Patent Literature 1). Two full-floating metal bearings are provided in the turbocharger described in Japanese Patent No. 3125227 (Patent Literature 2).

### SUMMARY

In recent years, speed-up of the rotation of the shaft is in demand. However, in a high-rotation region where a rotation number of the shaft is high, oil whirl (self-excited oscillation) can easily occur due to an influence of drag rotation of a lubricating oil supplied to a portion between the bearing surface and the shaft. Therefore, a measure against oil whirl needs to be taken.

It is an object of the present disclosure to provide a bearing structure and a turbocharger which can suppress occurrence of oil whirl and can improve stability of a rotating body in a high rotation region.

A first aspect of the present disclosure is a bearing structure including a shaft including an wheel provided at least at one end; and a bearing portion configured to rotatably support the shaft, wherein the bearing portion includes: a main body including a cylindrical shape; a bearing surface formed on an inner circumferential surface of the main body and configured to support the shaft; and a plurality of bearing grooves provided at intervals in a circumferential direction in the bearing surface and extending from one end to the other end of the shaft in a rotation axis direction; and wherein at least one of a shape and arrangement of the plurality of bearing grooves is asymmetrical to a center of a rotation axis in a section perpendicular to the rotation axis of the shaft.

The bearing portion may be a semi-floating metal bearing in which the two bearing surfaces are formed separate from each other in the rotation axis direction on the inner circumferential surface of the main body.

At least one of the plurality of bearing grooves may be a peculiar groove which has an area in the section perpendicular to the rotation axis of the shaft, the area being different from those of the other bearing grooves.

It may be constituted such that an oil path for supplying a lubricating oil is formed in a housing containing the bearing portion, the peculiar groove has an area larger than those of the other bearing grooves and is provided one in each of the bearing surfaces, and with an outlet end of the oil path facing the bearing portion as a starting point, the peculiar groove is disposed within a phase range from the starting point to 180 degrees to a front side in a rotating direction of the shaft.

It may be constituted such that an oil path for supplying a lubricating oil is formed in a housing containing the bearing portion, the peculiar groove has an area larger than those of the other bearing grooves and is provided one in each of the bearing surfaces, and with an outlet end of the oil path facing the bearing portion as a starting point, the peculiar groove is disposed within a phase range from the starting point to 180 degrees to a rear side in the rotating direction of the shaft.

The bearing portion may have a plurality of oil supply holes penetrating through from an outer circumferential surface to the respective bearing grooves; and at least one of the plurality of oil supply holes may have a size different from those of the other oil supply holes.

A second aspect of the present disclosure is a bearing structure including a shaft including an wheel provided at least at one end; and two full-floating metal bearings disposed separate from each other in an axial direction of the shaft and configured to rotatably support the shaft, wherein each full-floating metal bearing includes: a main body which has a cylindrical shape and through which the shaft is inserted; a bearing surface formed on an inner circumferential surface of the main body and configured to support the shaft; and a plurality of oil supply holes disposed in a circumferential direction of the main body, penetrating through from an outer circumferential surface to the bearing surface and guiding a lubricating oil to the bearing surface; and wherein at least one of a shape and arrangement of the plurality of oil supply holes is asymmetrical to a center of a rotation axis in a section perpendicular the rotation axis of the shaft.

At least one of the plurality of oil supply holes may have a size different from those of the other oil supply holes.

The full-floating metal bearing has a plurality of bearing grooves disposed at intervals in the circumferential direction on the bearing surface and extending from one end to the other end in the rotation axis direction of the shaft; and at least one of the plurality of bearing grooves may have a size different from those of the other bearing grooves.

A third aspect of the present disclosure is a turbocharger which includes the aforementioned bearing structure.

According to the present disclosure, occurrence of oil whirl is suppressed, and stability of a rotating body in a high rotation region can be improved.

### BRIEF DESCRIPTION OF THE DRAWINGS

FIG. 1 is an outline sectional view of a turbocharger according to an embodiment of the present disclosure.

FIG. 2 is an extracted view of a broken line portion in FIG. 1.

FIG. 3A to FIG. 3C are explanatory views for explaining a semi-floating metal bearing according to the embodiment of the present disclosure, in which FIG. 3A is a view of an end surface on a left side of the turbocharger in the semi-floating metal bearing when seen on front, FIG. 3B is a view illustrating a section on a III(b)-III(b) line in FIG. 3A, and FIG. 3C is a view illustrating a section on a III(c)-III(c) line in FIG. 3B.

FIG. 4A to FIG. 4D are views for explaining first to third modified examples of the embodiment of the present disclosure, in which FIG. 4A and FIG. 4B are a first modified example, FIG. 4C is a second modified example, and FIG. 4D is a third modified example.

FIG. 5A and FIG. 5B are views for explaining a fourth modified example of the embodiment of the present disclosure.

FIG. 6 is a view for explaining a fifth modified example of the embodiment of the present disclosure.

FIG. 7A to FIG. 7C are views for explaining a full-floating metal bearing according to the embodiment of the present disclosure.

### DESCRIPTION OF THE EMBODIMENTS

An embodiment of the present disclosure will be described below in detail by referring to the attached drawings. Dimensions, materials and other specific numerical values and the like illustrated in such an embodiment are only exemplification for facilitation of understanding of the disclosure and do not limit the present disclosure unless otherwise specified. In this Description and drawings, elements including substantially the same functions and constitutions are given the same reference numerals, and duplicated explanation will be omitted, and elements not directly relating to the present disclosure are not illustrated.

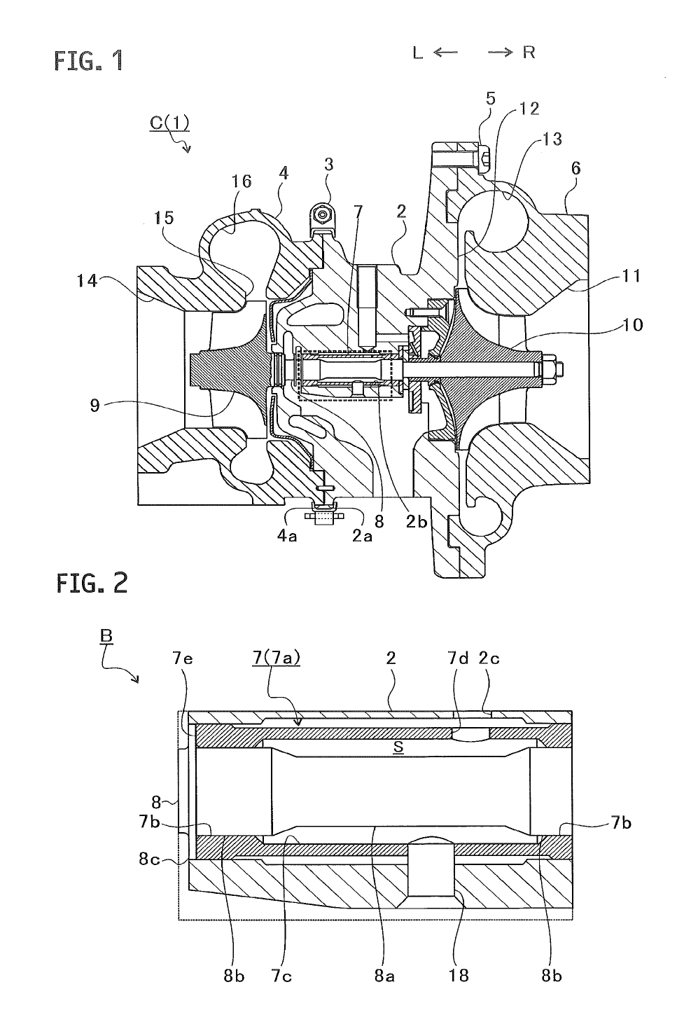

FIG. 1 is an outline sectional view of a turbocharger C. In the following, it is assumed that an arrow L illustrated in FIG. 1 is a direction indicating a left side of the turbocharger C and an arrow R is a direction indicating a right side of the turbocharger C in the explanation. As illustrated in FIG. 1, the turbocharger C includes a turbocharger main body 1. The turbocharger main body 1 has a bearing housing 2, a turbine housing 4 connected to a left side of the bearing housing 2 by a fastening mechanism 3, and a compressor housing 6 connected to a right side of the bearing housing 2 by a fastening bolt 5. They are integrated.

An outer circumferential surface of the bearing housing 2 has a projection 2a. The projection 2a is provided in a vicinity of the turbine housing 4 and projects to a radial direction of the bearing housing 2. Moreover, an outer circumferential surface of the turbine housing 4 has a projection 4a. The projection 4a is provided in a vicinity of the bearing housing 2 and projects to a radial direction of the turbine housing 4. The bearing housing 2 and the turbine housing 4 are fixed by band-fastening of the projections 2a and 4a with the fastening mechanism 3. The fastening mechanism 3 is constituted by a fastening band (a G-coupling, for example) for sandwiching the projections 2a and 4a.

A bearing hole 2b is formed in the bearing housing 2. The bearing hole 2b penetrates through the turbocharger C in the right-and-left direction. A semi-floating metal bearing 7 (bearing portion) is provided in the bearing hole 2b. The semi-floating metal bearing 7 rotatably supports a shaft 8. A turbine wheel 9 is integrally fixed to a left end portion of the shaft 8. The turbine wheel 9 is rotatably contained in the turbine housing 4. Further, a compressor wheel 10 is integrally fixed to a right end portion of the shaft 8. The compressor wheel 10 is rotatably contained in the compressor housing 6.

An intake port 11 is formed in the compressor housing 6. The intake port 11 is opened on the right side of the turbocharger C and is connected to an air cleaner (not shown). Further, when the bearing housing 2 and the compressor housing 6 are connected by the fastening bolt 5, facing surfaces of the both housings 2 and 6 form a diffuser flow path 12 which raises a pressure of air. The diffuser flow path 12 is formed annularly from an inner side to an outer side in a radial direction of the shaft 8 (compressor wheel 10). Moreover, the diffuser flow path 12 communicates with the intake port 11 through the compressor wheel 10 on the inner side in the radial direction.

A compressor scroll flow path 13 is provided in the compressor housing 6. The compressor scroll flow path 13 is formed annularly and is located on the outer side in the radial direction of the shaft 8 (compressor wheel 10) from the diffuser flow path 12. The compressor scroll flow path 13 communicates with an intake port (not shown) of the engine. Moreover, the compressor scroll flow path 13 communicates also with the diffuser flow path 12. Therefore, when the compressor wheel 10 is rotated, the air is suctioned into the compressor housing 6 from the intake port 11, accelerated by an action of a centrifugal force in a process of flowing through blades of the compressor wheel 10, boosted by the diffuser flow path 12 and the compressor scroll flow path 13 and led to the intake port of the engine.

A discharge port 14 is formed in the turbine housing 4. The discharge port 14 is opened in the left side of the turbocharger C and is connected to an exhaust gas purifying device (not shown). Moreover, a flow path 15 and a turbine scroll flow path 16 are provided in the turbine housing 4. The turbine scroll flow path 16 is formed annularly and is located on the outer side in the radial direction of the shaft 8 (turbine wheel 9) from the flow path 15. The turbine scroll flow path 16 communicates with a gas inlet (not shown) to which the exhaust gas exhausted from an exhaust manifold (not shown) of the engine is led. Moreover, the turbine scroll flow path 16 communicates also with the flow path 15. Therefore, the exhaust gas is led from the gas inlet to the turbine scroll flow path 16 and is led to the discharge port 14 through the flow path 15 and the turbine wheel 9. In this flow process, the exhaust gas rotates the turbine wheel 9. Then, a rotating force of the turbine wheel 9 is transmitted to the compressor wheel 10 through the shaft 8, and the air is boosted by the rotating force of the compressor wheel 10 and is led to the intake port of the engine.

FIG. 2 is a view for explaining a bearing structure B of the turbocharger C and is an extracted view of a broken line portion of FIG. 1. As illustrated in FIG. 2, the bearing structure B includes the semi-floating metal bearing 7 and the shaft 8.

The semi-floating metal bearing 7 has a cylindrically-shaped main body 7a. The shaft 8 is inserted through the main body 7a. Two bearing surfaces 7b and 7b are provided on an inner circumferential surface of the main body 7a. The bearing surfaces 7b and 7b are separated from each other in a rotation axis direction (hereinafter referred to simply as an axial direction) of the shaft 8.

Moreover, between the two bearing surfaces 7b and 7b in the axial direction, a non-bearing surface 7c is provided as an inner circumferential surface of the main body 7a. An inner diameter of the bearing surface 7b is smaller than an inner diameter of the non-bearing surface 7c.

On a portion inserted through the main body 7a of the semi-floating metal bearing 7 in the shaft 8, a small-diameter portion 8a and two large-diameter portions 8b and 8b are formed. Each of the large-diameter portions 8b has a diameter larger than that of the smaller diameter portion 8a. The large-diameter portions 8b are formed on both sides of the small-diameter portion 8a in the axial direction, respectively. Each of the large-diameter portions 8b faces the bearing surface 7b of the corresponding semi-floating metal bearing 7 in the radial direction of the shaft 8.

The non-bearing surface 7c of the semi-floating metal bearing 7 and the shaft 8 are separated from each other in the radial direction of the shaft 8. Thus, a gap S is formed in the main body 7a. Then, an oil path 7d is provided in the semi-floating metal bearing 7. The oil path 7d penetrates through the semi-floating metal bearing 7 in the radial direction of the shaft 8 and is opened in the non-bearing surface 7c. Moreover, the oil path 7d faces an oil path 2c formed in the bearing housing 2. The oil path 7d supplies the lubricating oil to the gap S.

The semi-floating metal bearing 7 has its relative movement with respect to the bearing housing 2 regulated by a pin 18. When the shaft 8 is rotated, relative rotational movement is generated between the large-diameter portion 8b of the shaft 8 and the bearing surface 7b of the semi-floating metal bearing 7. At this time, the lubricating oil supplied to the gap S lubricates the two bearing surfaces 7b, whereby the shaft 8 is rotatably supported by the bearing surface 7b.

Moreover, a collar 8c is provided in the shaft 8. The collar 8c is located on the turbine wheel 9 side in the large-diameter portion 8b of the turbine wheel 9 side (left side in FIG. 2) and is formed continuously to the large-diameter portion 8b. Moreover, the collar 8c has an outer diameter larger than the large-diameter portion 8b. The collar 8c faces an end surface 7e of the semi-floating metal bearing 7 on the turbine wheel 9 side and is integrally rotated with the shaft 8. The semi-floating metal bearing 7 receives a thrust load of the shaft 8 through the collar 8c.

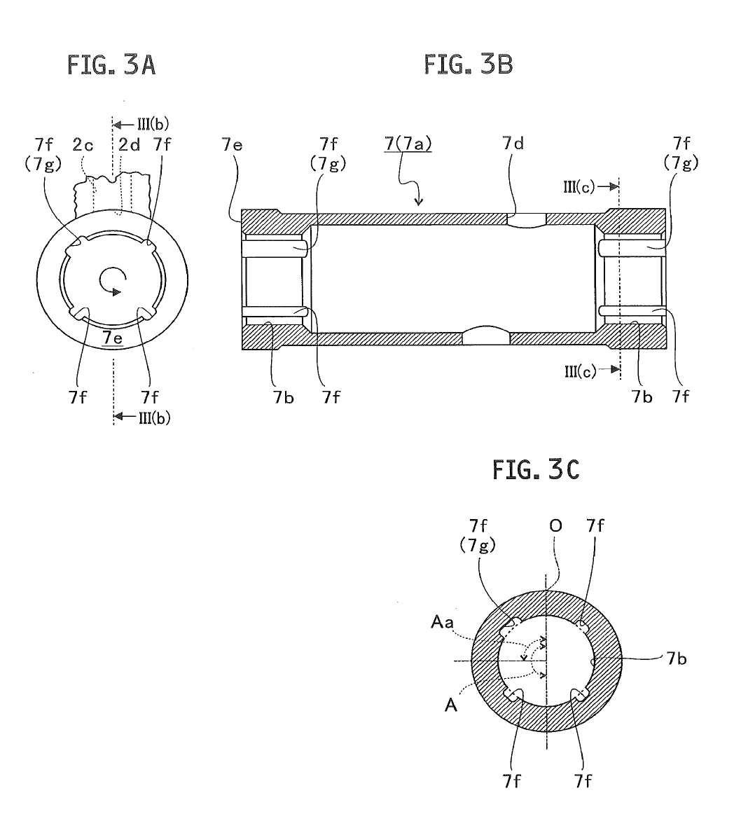

FIG. 3A to FIG. 3C are views for explaining the semi-floating metal bearing 7. FIG. 3A is a view of the end surface 7e on the left side of the turbocharger C in the semi-floating metal bearing 7 when seen on front. For convenience of explanation, FIG. 3A extracts and illustrates a part of the bearing housing 2. FIG. 3B is a view illustrating a section on a III(b)-III(b) line in FIG. 3A, and FIG. 3C is a view illustrating a section on a III(c)-III(c) line in FIG. 3B.

As illustrated in FIG. 3A and FIG. 3B, a bearing groove 7f is formed in the bearing surface 7b of the semi-floating metal bearing 7. The bearing grooves 7f are disposed in plural (four grooves, here) at intervals in a circumferential direction of the shaft 8 and extend from one end to the other end in the axial direction. Here, the bearing groove 7f extends along the axial direction.

Moreover, one of the plurality of bearing grooves 7f is a peculiar groove 7g. An area in a section (a section illustrated in FIG. 3C, for example) perpendicular to a rotation axis of the shaft 8 of the peculiar groove 7g is different from those of the other bearing grooves 7f. In FIG. 3C, the area of the peculiar groove 7g is an area of a region surrounded by an extension line (indicated by a broken line) of the bearing surface 7b and a wall surface of the peculiar groove 7g.

In the circumferential direction of the semi-floating metal bearing 7, a width of the peculiar groove 7g (hereinafter referred to simply as a groove width) is larger than those of the other bearing grooves 7f and the area is larger than those of the other bearing grooves 7f. That is, the plurality of bearing grooves 7f has a shape asymmetrical to a rotation axis center in the section perpendicular to the rotation axis of the shaft 8.

Incidentally, in a high rotation region where a rotation number of the shaft 8 is high, oil whirl (self-excited oscillation) can easily occur due to an influence of drag rotation of the lubricating oil supplied to the space between the bearing surface 7b and the shaft 8. The oil whirl (self-excited oscillation) can occur particularly easily if eccentricity is small. Here, eccentricity means a degree of deviation of the rotation axis center (a shaft core of the semi-floating metal bearing 7 in the illustrated example) of the shaft 8 with respect to a shaft core (center axis) of the shaft 8. In other words, eccentricity indicates a degree of an amount (eccentricity amount) of deviation of the shaft core of the shaft 8 with respect to the shaft core of the semi-floating metal bearing 7 during rotation of the shaft 8. This eccentricity is, for example, expressed as a ratio of the deviation amount of the shaft core of the shaft 8, when the shaft core of the shaft 8 is located concentrically with the semi-floating metal bearing 7, during rotation of the shaft 8 with respect to the gap between the both.

In this embodiment, the aforementioned peculiar groove 7g is provided. Thus, a difference is generated in an amount of the lubricating oil supplied to the grooves between the peculiar groove 7g and the other bearing grooves 7f. As a result, an oil film pressure generated between the shaft 8 and the bearing surface 7b becomes non-uniform in a diagonal direction (rotating direction) of the shaft 8, which can increase eccentricity.

Thus, in the semi-floating metal bearing 7, occurrence of oil whirl is suppressed, and stability in the high rotation region can be improved.

An outlet end 2d of the oil path 2c faces the semi-floating metal bearing 7. The outlet end 2d is disposed on an upper side of the semi-floating metal bearing 7 in FIG. 3A. Note that, in FIGS. 3A, 3B, and 3C, it is assumed that the upper side is a vertically upper side and a lower side is a vertically lower side.

The peculiar groove 7g is provided one each in each of the bearing surfaces 7b. Then, the peculiar groove 7g is disposed in a phase range A in the bearing surface 7b. The phase range A is a range obtained by rotation of 180 degrees to the front side (indicated by an arrow in FIG. 3A) in the rotating direction of the shaft 8 with the outlet end 2d of the oil path 2c as a starting point. In other words, it refers to, with the outlet end 2d of the oil path 2c as a starting point (that is, a phase angle at 0 degrees), a range from the starting point (0 degrees) to 180 degrees to the front side in the rotating direction of the shaft 8 (that is, in a forward rotating direction). Note that, the starting point is assumed to be the center in a width of the outlet end 2d in the rotating direction of the shaft 8. FIG. 3C indicates a position O corresponding to that.

In detail, the peculiar groove 7g is disposed in a range Aa in the phase range A. Here, the range Aa is a range obtained by rotation of 90 degrees to the front side in the rotating direction of the shaft 8 with the position O (outlet end 2d) as a starting point. In other words, the range Aa refers to a phase range from the starting point (position O, outlet end 2d) to 90 degrees to the front side in the rotating direction of the shaft 8 (that is, in the forward rotating direction). In further other words, the range Aa refers to a range from the center of the phase range A (that is, 90 degrees from the position O) to 90 degrees to the rear side in the rotating direction (in a backward rotating direction).

Since the outlet end 2d of the oil path 2c is disposed on the vertically upper side of the semi-floating metal bearing 7, the oil path 7d of the semi-floating metal bearing 7 is disposed on the vertically upper side of the semi-floating metal bearing 7 so as to face the outlet end 2d. Thus, the lubricating oil supplied into the semi-floating metal bearing 7 is supplied from the vertically upper side toward the vertically lower side.

As described above, the shaft 8 is rotated in a direction of an arrow illustrated in FIG. 3A. Therefore, the lubricating oil is also rotated in the same direction so as to follow the shaft 8. That is, drag rotation of the lubricating oil occurs. As a result, the lubricating oil is easily supplied to the vertically upper side, while the supply is getting difficult as it goes toward the front side in the rotating direction from the vertically upper side.

That is, if there are four bearing grooves 7f as illustrated in FIG. 3A, the upper left bearing groove 7f located in the range Aa in FIG. 3C is disposed on an uppermost stream in a flow direction of the lubricating oil with the outlet end 2d as the starting point. Therefore, the lubricating oil can be supplied to the upper left bearing groove 7f more easily than to the other bearing grooves 7f. Thus, it is possible to increase eccentricity effectively and suppress occurrence of oil whirl by forming the upper left bearing groove 7f as the peculiar groove 7g in FIG. 3A.

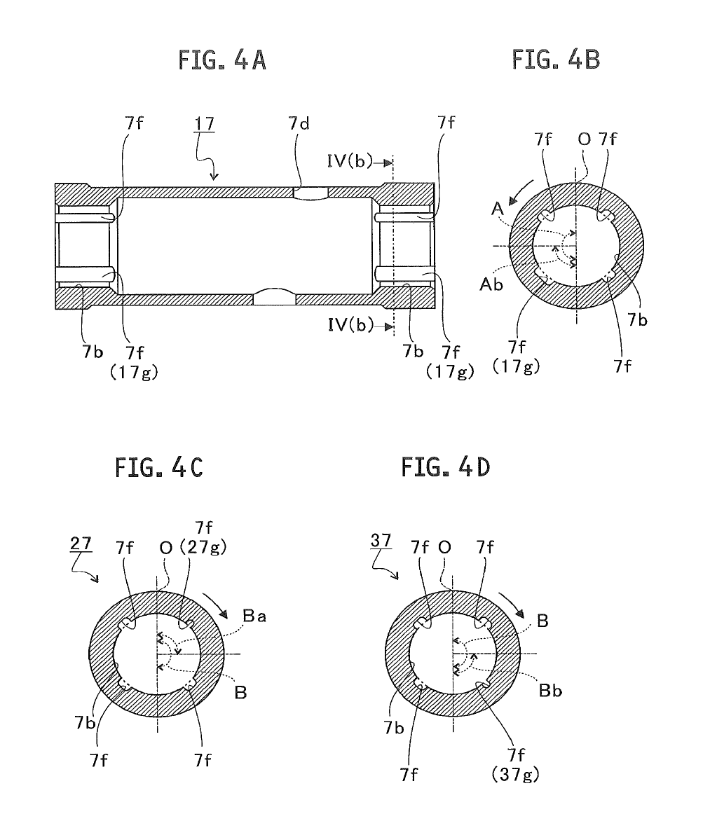

FIG. 4A to FIG. 4C are views for explaining first to third modified examples. FIG. 4A illustrates a section of a portion in the first modified example corresponding to FIG. 3B in the aforementioned embodiment, and FIG. 4B illustrates a section on a IV(b)-IV(b) line in FIG. 4A.

As illustrated in FIG. 4A and FIG. 4B, in a semi-floating metal bearing 17 of the first modified example, a lower left bearing groove 7f in FIG. 4A is provided as a peculiar groove 17g. That is, the peculiar groove 17g is disposed in a range Ab in the phase range A. Here, the range Ab is a phase range of 90 degrees on the front side in the rotating direction. In other words, the range Ab refers to a phase range from the center of the phase range A to 90 degrees to the front side in the rotating direction (in the forward rotating direction).

If the lubricating oil is supplied to the plurality of bearing grooves with different groove widths, the lubricating oil tends to be supplied more easily to the groove with a large groove width than the groove with a small groove width. As illustrated in FIG. 4B, it is possible to improve eccentricity in the high rotation region and suppress occurrence of oil whirl by setting arrangement of the peculiar groove 17g in the range on the front side in the rotating direction. Moreover, it is possible to adjust eccentricity of the shaft 8 more finely than in the aforementioned embodiment by providing the lower left bearing groove 7f as the peculiar groove 17g with a large groove.

FIG. 4C illustrates a section of a portion corresponding to FIG. 3C in the aforementioned embodiment in a second modified example. As illustrated in FIG. 4C, in a semi-floating metal bearing 27 in the second modified example, one of the four bearing grooves 7f is provided as a peculiar groove 27g. The peculiar groove 27g has a groove width smaller than those of the other bearing grooves 7f and an area regulated above smaller than the other bearing grooves 7f.

The upper right bearing groove 7f in FIG. 4C is provided as the peculiar groove 27g. That is, the peculiar groove 27g is disposed in a phase range B in the bearing surface 7b. The phase range B refers to a range obtained by rotation of 180 degrees to the rear side in the rotating direction (indicated by a solid arrow in FIG. 4C) of the shaft 8 with the position O of the oil path 2c as the starting point. In other words, the phase range B is a range, with the position O of the oil path 2c as a starting point, from the starting point to 180 degrees in the rear side in the rotating direction of the shaft 8 (in the backward rotating direction). In detail, the peculiar groove 27g according to the second modified example is disposed in a range Ba in the phase range B. Here, the range Ba refers to a phase range to 90 degrees on the rear side in the rotating direction. In other words, the range Ba refers to a phase range obtained by rotation of 90 degrees to the rear side in the rotating direction of the shaft 8 with the position O as the starting point. In further other words, the range Ba refers to a phase range from the starting point to 90 degrees to the rear side in the rotating direction (in the backward rotating direction).

As described above, the lubricating oil is easily supplied to the vertically upper side, while the supply is getting difficult as it goes toward the front side in the rotating direction from the vertically upper side. That is, if there are four bearing grooves 7f as illustrated in FIG. 4C, the supply of the lubricating oil to the upper right bearing groove 7f in FIG. 4C is smaller than that to the other bearing grooves 7f. Thus, it is possible to increase eccentricity effectively and suppress occurrence of oil whirl by setting the upper right bearing groove 7f in FIG. 4C as the peculiar groove 27g with a small groove width.

FIG. 4D illustrates a section of a portion corresponding to FIG. 3C in the aforementioned embodiment in a third modified example. As illustrated in FIG. 4D, in a semi-floating metal bearing 37 in the third modified example, a peculiar groove 37g has a groove width smaller than those of the other bearing grooves 7f and the aforementioned area smaller than those of the other bearing grooves 7f, as in the second modified example.

The peculiar groove 37g is the lower right bearing groove 7f in FIG. 4D. That is, the peculiar groove 37g is disposed in the range Bb in the phase range B in the bearing surface 7b. Here, the range Bb is a phase range to 90 degrees on the rear side in the rotating direction. In other words, the range Bb refers to a phase range from the center of the phase range B to 90 degrees on the rear side in the rotating direction (in the backward rotating direction).

Since the lower right bearing groove 7f in FIG. 4D is provided as the peculiar groove 37g, the supply of the lubricating oil to the peculiar groove 37g tends to be smaller similarly to the second modified example. As described above, it is possible to increase eccentricity effectively in the high rotation region and suppress occurrence of oil whirl by setting arrangement of the peculiar groove 37g with a small groove width to a range on the rear side in the rotating direction. However, it is possible to adjust eccentricity more finely than in the aforementioned second modified example by providing the lower right bearing groove 7f as the peculiar groove 17g with a small groove width.

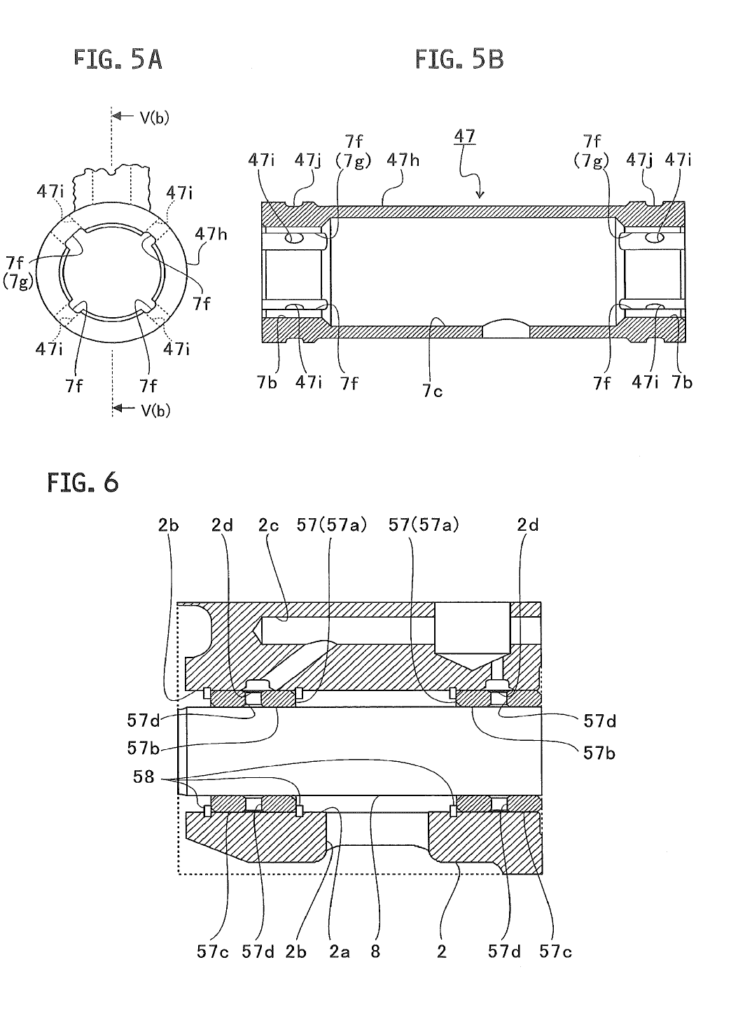

FIG. 5A and FIG. 5B are views for explaining a fourth modified example. FIG. 5A illustrates an end surface corresponding to FIG. 3A in the fourth modified example. FIG. 5B illustrates a section on a V(b)-V(b) line in FIG. 5A. As illustrated in FIG. 5A and FIG. 5B, in the fourth modified example, a semi-floating metal bearing 47 has a plurality of oil supply holes 47i instead of the oil path 7d opened in the non-bearing surface 7c. Each of the oil supply holes 47i penetrates through from an outer circumferential surface 47h to the respectively corresponding bearing grooves 7f.

The oil supply hole 47i is provided one each for each of the bearing grooves 7f. Each of the bearing grooves 7f extends from the bearing groove 7f to the outer circumferential surface 47h outward in the radial direction. Moreover, as illustrated in FIG. 5B, an outer circumferential groove 47j is formed in the outer circumferential surface 47h. The outer circumferential groove 47j is an annular groove dented in the radial direction and allows the four oil supply holes 47i to communicate in the circumferential direction.

The oil path 2c provided in the bearing housing 2 communicates to a portion where the outer circumferential groove 47j is located in the bearing hole 2b. Therefore, the lubricating oil is directly supplied to the outer circumferential groove 47j. The lubricating oil is supplied to the outer circumferential groove 47j, and while flowing in the circumferential direction along the outer circumferential groove 47j, it flows to the respective oil supply holes 47i and is supplied to the bearing surface 7b through the oil supply hole 47i.

The upper left oil supply hole 47i in FIG. 5A in the plurality of oil supply holes 47i, communicates with the peculiar groove 7g with a groove width larger than those of the other bearing grooves 7f. Moreover, this oil supply hole 47i is larger than the other oil supply holes 47i. That is, the upper left oil supply hole 47i has a size different from those of the other oil supply holes 47i. Thus, the lubricating oil can be supplied to the peculiar groove 7g more easily than to the other bearing grooves 7f, whereby eccentricity can be improved and occurrence of oil whirl can be suppressed similarly to the aforementioned embodiment. Moreover, in this modified example, an entire supply amount is reduced by directly supplying the lubricating oil to the outer circumferential groove 47j, and a mechanical loss can be reduced.

In this modified example, it is only necessary that at least one oil supply hole 47i has a size different from those of the other oil supply holes 47i. For example, the peculiar groove 7g may have a groove width smaller than the other bearing grooves 7f or the oil supply hole 47i communicating with the peculiar groove 7g may be smaller than the other oil supply holes 47i.

Moreover, it may be so constituted that the oil supply hole 47i with a size different from those of the other oil supply holes 47i does not communicate with the peculiar groove 7g but communicates with the other bearing grooves 7f. In any case, in addition to the setting of the peculiar groove 7g, it is possible to expand more easily a degree of freedom of adjustment for improving eccentricity by setting the oil supply hole 47i with the different size.

FIG. 6 is a view for explaining a fifth modified example and extracts and illustrates a section in the vicinity of the bearing portion in the fifth modified example. As illustrated in FIG. 6, in the fifth modified example, the bearing portion is constituted by full-floating metal bearings 57. Two full-floating metal bearings 57 are disposed separate from each other in the axial direction.

The full-floating metal bearing 57 includes a main body 57a including a cylindrical shape. The shaft 8 is inserted into the main body 57a. The full-floating metal bearing 57 disposed on the turbine wheel 9 side is sandwiched by two rings 58 from front and rear in the axial direction and has its axial movement regulated. Moreover, the full-floating metal bearing 57 disposed on the compressor wheel 10 side is sandwiched by the ring 58 from a left side in the axial direction and a thrust bearing, not shown, from a right side and its movement in the axial direction is regulated.

The oil path 2c provided in the bearing housing 2 communicates to portions where the respective full-floating metal bearings 57 are disposed in the bearing hole 2b. Therefore, the lubricating oil is directly supplied to the full-floating metal bearing 57.

A bearing surface 57b supporting the shaft 8 is formed on an inner circumferential surface of the main body 57a of the full-floating metal bearing 57. Then, an oil supply hole 57d is formed in the main body 57a. The oil supply hole 57d penetrates through from the outer circumferential surface 57c of the main body 57a to the bearing surface 57b and leads the lubricating oil to the bearing surface 57b.

The oil supply hole 57d has a position relation in which its position in the axial direction is overlapped with the outlet end 2d of the oil path 2c. The full-floating metal bearing 57 is rotated with a rotation number substantially a half of that of the shaft 8 so as to follow the shaft 8. With rotation of the shaft 8, drag rotation of the full-floating metal bearing 57 is generated. The lubricating oil is led to the bearing surface 57b through the oil supply hole 57d. Moreover, the lubricating oil flows to a gap between the outer circumferential surface 57c of the full-floating metal bearing 57 and the bearing hole 2b and supports movement of the full-floating metal bearing 57 with respect to the bearing hole 2b.

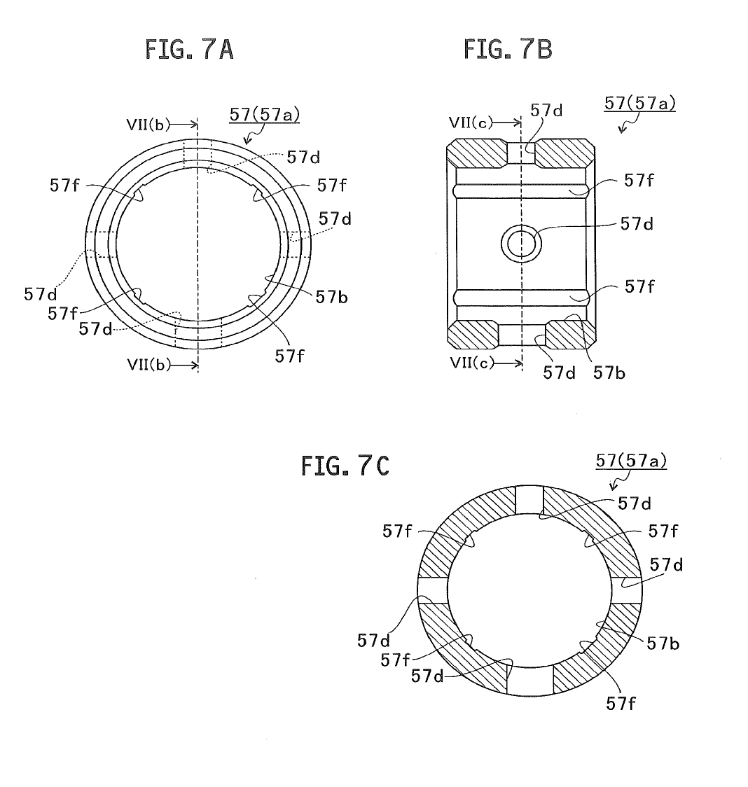

FIG. 7A to FIG. 7C are views for explaining the full-floating metal bearing 57. FIG. 7A is a view of an end surface in the axial direction in the full-floating metal bearing 57 when seen from a front. FIG. 7B illustrates a section on a VII(b)-VII(b) line in FIG. 7A. FIG. 7C illustrates a section on a VII(c)-VII(c) line in FIG. 7B.

As illustrated in FIG. 7A and FIG. 7C, the oil supply holes 57d are formed in plural (here, four holes) in the circumferential direction of the main body 57a of the full-floating metal bearing 57. In a section (a section illustrated in FIG. 7C, for example) perpendicular to the rotation axis of the shaft 8, the shapes of the plurality of oil supply holes 57d are asymmetrical to the rotation axis center. For example, the oil supply hole 57d on a lower side in FIG. 7C in the plurality of oil supply holes 57d is larger than the other oil supply holes 57d.

Thus, the lubricating oil in an amount larger than those to the other oil supply holes 57d is supplied to the oil supply hole 57d on the lower side in FIG. 7C. As a result, the oil film pressure generated between the shaft 8 and the bearing surface 57b becomes non-uniform in a diagonal direction of the shaft 8, whereby eccentricity can be increased. Thus, occurrence of oil whirl is reduced, and stability in the high rotation region can be improved.

Moreover, a bearing groove 57f is provided in the bearing surface 57b of the full-floating metal bearing 57. The bearing grooves 57f are disposed in plural (here, four grooves) at intervals in the circumferential direction of the full-floating metal bearing 57. Each of the bearing grooves 57f extends from one end to the other end in the axial direction of the shaft 8.

The bearing groove 57f is provided between openings of the oil supply holes 57d adjacent in the circumferential direction. Then, one of the plurality of bearing grooves 57f (the lower right bearing groove 57f in FIG. 7A and FIG. 7C) is larger than the other bearing grooves 57f. That is, the lower right bearing groove 57f has a size different from those of the other bearing grooves 57f. As a result, the oil film pressure generated in the bearing surface 57b becomes non-uniform in the diagonal direction of the shaft 8.

Thus, in addition to the oil supply hole 57d, it becomes easy to expand a degree of freedom of adjustment for improving eccentricity by setting the bearing groove 57f with a different size, for example.

In the aforementioned embodiment and modified examples, the case where the groove is present on a diagonal line to the peculiar grooves 7g, 17g, 27g, and 37g (in other words, on the opposite side with the shaft core of the semi-floating metal bearing between them) is described. However, a phase where the groove is disposed may be arbitrary such that three grooves are disposed at a 120° pitch, for example, as long as the shape is asymmetrical to the rotation axis center.

In the aforementioned embodiment and modified examples, the case where the shape is asymmetrical to the rotation axis center in the section perpendicular to the rotation axis of the shaft 8 by providing the peculiar grooves 7g, 17g, 27g, and 37g is described. However, it may be so constituted that a pitch (interval) of the bearing grooves 7f in the circumferential direction is made non-uniform, and arrangement of the bearing grooves 7f is made asymmetrical to the rotation axis center in the section perpendicular to the rotation axis of the shaft 8.

However, it is possible to dispose the peculiar groove in an appropriate phase without increasing the pitch by providing the peculiar grooves 7g, 17g, 27g, and 37g so as to break symmetry by the shape, for example. As a result, occurrence of oil whirl can be suppressed while partial shortage of the lubricating oil of the bearing surface 7b is suppressed.

Moreover, in the aforementioned embodiment and modified examples, the case where the peculiar grooves 7g, 17g, 27g, and 37g are provided one each on each of the bearing surfaces 7b, but a plurality of them may be provided for each of the bearing surfaces 7b.

Moreover, in the aforementioned embodiment and modified examples, the case where the peculiar grooves 7g, 17g, 27g, and 37g have different groove widths from those of the other bearing grooves 7f is described, but not limited to the groove width, it is only necessary that an area in a section (the section illustrated in FIG. 3C, for example) perpendicular to the rotation axis of the shaft 8 is different.

Moreover, in the aforementioned fifth modified example, the case where in the full-floating metal bearing 57, the size of one of the oil supply holes 57d is larger than those of the other oil supply holes 57d is described, but it may be so constituted that the pitch in the circumferential direction of the oil supply hole 57d is made non-uniform, and the arrangement of the oil supply holes 57d is made asymmetry to the rotation axis center in the section perpendicular to the rotation axis of the shaft 8.

However, it is possible to suppress occurrence of oil whirl while avoiding such a situation that, as the result of widened pitch, the lubricating oil of the bearing surface 7b becomes partially too thin, by breaking asymmetry by the shape of the oil supply hole 57d.

Moreover, in the aforementioned fifth modified example, the case where in the full-floating metal bearing 57, the size of one of the oil supply holes 57d is larger than those of the other oil supply holes 57d is described, but the size of the one oil supply hole 57d may be smaller than those of the other oil supply holes 57d or the size of two or more of the oil supply holes 57d may be different from the sizes of the other oil supply holes 57d.

The embodiments of the present disclosure have been described above by referring to the attached drawings, but it is needless to say that the present disclosure is not limited to such embodiments. It is obvious that those skilled in the art could conceive of various changes and modifications within a range described in claims, and it is understood that they naturally belong to the technical range of the present disclosure.

What is claimed is:

1. A bearing structure, comprising:
a shaft including an wheel provided at least at one end; and
a bearing portion configured to rotatably support the shaft,
wherein the bearing portion includes:
a main body including a cylindrical shape;
a bearing surface formed on an inner circumferential surface of the main body and configured to support the shaft; and
a plurality of bearing grooves provided at intervals in a circumferential direction in the bearing surface and extending from one end to the other end of the shaft in a rotation axis direction; and
wherein at least one of a shape and arrangement of the plurality of bearing grooves is asymmetrical to a center of a rotation axis in a section perpendicular to the rotation axis of the shaft.

2. The bearing structure according to claim 1, wherein
the bearing portion is a semi-floating metal bearing in which the two bearing surfaces are formed separate from each other in the rotation axis direction on the inner circumferential surface of the main body.

3. The bearing structure according to claim 2, wherein
at least one of the plurality of bearing grooves is a peculiar groove which has an area in the section perpendicular to the rotation axis of the shaft, the area being different from those of the other bearing grooves.

4. The bearing structure according to claim 3,
wherein an oil path for supplying a lubricating oil is formed in a housing containing the bearing portion; and
wherein the peculiar groove has an area larger than those of the other bearing grooves and is provided one in each of the bearing surfaces, and with an outlet end of the oil path facing the bearing portion as a starting point, the peculiar groove is disposed within a phase range from the starting point to 180 degrees to a front side in a rotating direction of the shaft or within a phase range from the starting point to 180 degrees to a rear side in the rotating direction of the shaft.

5. The bearing structure according to claim 3, wherein
the bearing portion has:
a plurality of oil supply holes penetrating through from an outer circumferential surface to the respective bearing grooves; and
at least one of the plurality of oil supply holes has a size different from those of the other oil supply holes.

6. The bearing structure according to claim 4, wherein
the bearing portion has:
a plurality of oil supply holes penetrating through from an outer circumferential surface to the respective bearing grooves; and
at least one of the plurality of oil supply holes has a size different from those of the other oil supply holes.

7. A bearing structure, comprising:
a shaft including an wheel provided at least at one end; and
two full-floating metal bearings disposed separate from each other in an axial direction of the shaft and rotatably supporting the shaft,
wherein each full-floating metal bearing includes:
a main body which has a cylindrical shape and through which the shaft is inserted;
a bearing surface formed on an inner circumferential surface of the main body and configured to support the shaft; and
a plurality of oil supply holes disposed in a circumferential direction of the main body, penetrating through from an outer circumferential surface to the bearing surface and guiding a lubricating oil to the bearing surface; and
wherein at least one of a shape and arrangement of the plurality of oil supply holes is asymmetrical to a center of a rotation axis in a section perpendicular the rotation axis of the shaft.

8. The bearing structure according to claim 7, wherein
at least one of the plurality of oil supply holes has a size different from those of the other oil supply holes.

9. The bearing structure according to claim 7, wherein
the full-floating metal bearing has a plurality of bearing grooves disposed at intervals in the circumferential direction on the bearing surface and extending from one end to the other end in the rotation axis direction of the shaft; and
at least one of the plurality of bearing grooves has a size different from those of the other bearing grooves.

10. The bearing structure according to claim 8, wherein
the full-floating metal bearing has a plurality of bearing grooves disposed at intervals in the circumferential direction on the bearing surface and extending from one end to the other end in the rotation axis direction of the shaft; and
at least one of the plurality of bearing grooves has a size different from those of the other bearing grooves.

11. A turbocharger comprising a bearing structure according to claim 1.

12. A turbocharger comprising a bearing structure according to claim 7.
